(19) United States
(12) Patent Application Publication
(10) Pub. No.: US 2014/0002912 A1
(43) Pub. Date: Jan. 2, 2014

(54) LENS DRIVE DEVICE AND IMAGING DEVICE

(71) Applicants: Takuma Ishikawa, Itabashi-ku (JP); Hiroki Ito, Itabashi-ku (JP); Yohsuke Ikeda, Soka-shi (JP); Takafumi Ishikawa, Saitama-shi (JP); Hiroyuki Watanabe, Shiroi-shi (JP)

(72) Inventors: Takuma Ishikawa, Itabashi-ku (JP); Hiroki Ito, Itabashi-ku (JP); Yohsuke Ikeda, Soka-shi (JP); Takafumi Ishikawa, Saitama-shi (JP); Hiroyuki Watanabe, Shiroi-shi (JP)

(21) Appl. No.: 13/982,342

(22) PCT Filed: Jan. 31, 2012
(86) PCT No.: PCT/JP2012/052151

§ 371 Date: Jul. 29, 2013

(30) Foreign Application Priority Data
Jan. 31, 2011 (JP) 2011-018558
Jan. 31, 2012 (JP) 2012-017527

(51) Int. Cl. G02B 7/02

(52) U.S. Cl. CPC G02B 7/023
USPC 359/814; 359/813

(57) ABSTRACT

The present invention provides a lens drive device including a base, a lens frame holding a lens and provided to be movable with respect to the base in an optical axis direction of the lens, a light bending portion for bending incident light on the lens, a driving unit for moving the lens frame, and a position detection unit for detecting a position of the lens frame. The position detection unit includes a reflection portion provided to one of the base and the lens frame and including a reflection surface inclined with respect to the optical axis of the lens, and a photoreflector provided to the other of the base and the lens frame and including a light projecting portion applying light to the reflection surface and a light receiving portion receiving light reflected on the reflection surface.

### TECHNICAL FIELD

The present invention relates to a lens drive device that drives a lens, and an imaging device including the lens drive device.

### BACKGROUND ART

Japanese Patent Application Laid-Open Publication No. 2008-83396 is a technical literature in such a field. This publication describes a lens position detection mechanism including a photoreflector having a light projecting portion applying light and a light receiving portion receiving light, and a lens holder having a side surface portion opposed to the photoreflector and moving relative to the photoreflector. A through hole is formed in the side surface portion of the lens holder, and an interior reflector plate is exposed from the through hole. The position detection mechanism configured in this manner can detect the position of the lens holder based on the difference in amount of receiving light between when the photoreflector is opposed to the reflector plate and when it is not opposed.

### CITATION LIST

### Patent Literature

[Patent Literature 1] Japanese Patent Application Laid-Open Publication No. 2008-83396

### SUMMARY OF INVENTION

### Technical Problem

The conventional position detection mechanism described above, however, can detect the position of the lens only in two stages, namely, when the photoreflector is opposed to the reflector plate in the through hole and when it is not opposed, resulting in a low resolution which makes fine lens position detection impossible.

The present invention therefore aims to provide a lens drive device capable of lens position detection with high accuracy and high resolution.

### Solution to Problem

In order to solve the above-mentioned problem, the present invention provides a lens drive device which includes a base, a lens frame holding a lens and provided to be movable with respect to the base in an optical axis direction of the lens, a light bending portion for bending incident light on the lens, driving means for moving the lens frame, and position detection means for detecting a position of the lens frame. The position detection means includes a reflection portion provided to one of the base and the lens frame and including a reflection surface inclined with respect to the optical axis of the lens, and a photoreflector provided to the other of the base and the lens frame and including a light projecting portion applying light to the reflection surface and a light receiving portion receiving light reflected on the reflection surface.

In the lens drive device according to the present invention, the distance between the reflection surface of the reflection portion and the photoreflector changes in accordance with the position of the lens frame, so that the position of the lens frame can be detected by detecting this distance with the photoreflector. Since the reflection surface is inclined with respect to the optical axis, the distance between the reflection surface and the photoreflector continuously changes in accordance with the position of the lens frame. Since the reflection surface is a flat surface having constant inclination, the position of the lens frame can be specified based on the distance between the reflection surface and the photoreflector. Accordingly, this lens drive device can detect the distance from the reflection surface using the photoreflector thereby precisely specifying the position of the lens frame corresponding to the detected distance. Accordingly, lens position detection can be performed with high accuracy and high resolution.

In the lens drive device according to the present invention, it is preferable that the reflection surface of the reflection portion and a light projecting/receiving surface of the photoreflector face each other.

In the lens drive device according to the present invention, the reflection surface and the light projecting/receiving surface face each other, so that light can be reliably projected and received by the photoreflector, compared with a case where they do not face each other. The detection accuracy of the photoreflector is thus improved.

In the lens drive device according to the present invention, it is preferable that the reflection portion be provided to the lens frame, the driving means include a magnet provided to the base and a coil provided to the lens frame, and the lens frame include a coil holding portion integrally formed with the reflection portion for holding the coil.

In the lens drive device according to the present invention, the coil holding portion and the reflection portion are formed integrally in the lens frame, thereby simplifying the structure and reducing the size of the device.

In the lens drive device according to the present invention, it is preferable that, in an output voltage characteristic of the photoreflector with respect to a distance between the reflection surface and the photoreflector, a range in which a rate of change of the output voltage with respect to the distance is high be set as a lens position detection area for either a lens position detection area for short distance or a lens position detection area for long distance, and another range in which the rate of change is smaller than in the range be used for the other lens position detection.

In the lens drive device according to the present invention, the lens position detection area for short distance and the lens position detection area for long distance are set in accordance with the magnitude of the rate of change of the output voltage with respect to the detected distance in the lens position detection area for focus, thereby implementing lens position detection suited for respective imaging conditions for short distance and for long distance.

In the lens drive device according to the present invention, it is preferable that the base have a guide groove extending in the optical axis direction, and the lens frame include a projection portion that is engaged with the guide groove and is slidable along the guide groove.

In the lens drive device according to the present invention, the projection portion engaged with the guide groove of the guide member slides along the guide groove in accordance with the movement of the lens frame, thereby allowing the lens frame to be moved accurately in the optical axis direction. In this lens drive device compared with a case where a guide shaft is provided, the number of components can be reduced, thereby reducing the cost of the device. This configuration is also advantageous in size reduction of the device.

In the lens drive device according to the present invention, it is preferable that the base have a visual recognition hole for visually recognizing the lens frame.

In the lens drive device according to the present invention, the visual recognition hole in the base is used to facilitate position adjustment of the lens frame even after the lens drive device is mounted on the imaging device, thereby improving the efficiency of assembly operation.

In the lens drive device according to the present invention, it is preferable that the reflection surface be a flat surface or a curved surface capable of collecting light.

Forming the reflection surface in a curved surface capable of collecting light enables sensing light efficiently with a small quantity of light and improving the accuracy of position detection even with a small reflection portion.

In the lens drive device according to the present invention, it is preferable that the reflection surface be formed in a sawtooth shape in a cross section.

By employing such a configuration, the inclination angle of the reflection surface can be increased. This can increase a change in the amount of receiving light and can improve the accuracy of position detection even if the reflection portion is small.

An imaging device according to the present invention includes the lens drive device as described above.

The imaging device according to the present invention can perform detection of the position of the lens frame with high accuracy and high resolution, thereby improving the imaging performance.

### Advantageous Effects of Invention

The present invention enables lens position detection with high accuracy and high resolution.

### BRIEF DESCRIPTION OF DRAWINGS

FIG. 1 is a side sectional view showing a lens drive device according to a first embodiment.

FIG. 2 is a plan view showing the lens drive device in FIG. 1.

FIG. 3 is a perspective view showing the lens drive device in FIG. 1.

FIG. 4 is a side sectional view of the lens drive device showing a state in which a focus lens N is at a stopper position.

FIG. 5 is a schematic diagram for explaining lens position detection in the lens drive device in FIG. 1.

FIG. 6 is a graph for explaining another example of a fine movement area and a coarse movement area of an output voltage characteristic of a photoreflector.

FIG. 7 is a graph for explaining another example of the fine movement area and the coarse movement area of the output voltage characteristic of the photoreflector.

FIG. 8 is a schematic diagram for explaining a lens drive device according to a second embodiment.

FIG. 9 is a perspective view showing a lens drive device according to a third embodiment.

FIG. 10 is a sectional view showing a base member and a lens frame in FIG. 11.

FIG. 11 is an enlarged sectional view showing a guide projection portion of the lens frame in FIG. 11.

FIG. 12 is a perspective view showing another modification of a reflection surface.

FIG. 13 is a perspective view showing yet another modification of the reflection surface.

FIG. 14 is a perspective view showing yet another modification of the reflection surface.

### DESCRIPTION OF EMBODIMENTS

Preferred embodiments of the present invention will be described below in detail with reference to the drawings. In the drawings, the same or corresponding parts are denoted with the same reference signs and an overlapping description is omitted. The size, shape, and magnitude relation between components in the drawings are not always the same as the actual ones.

### First Embodiment

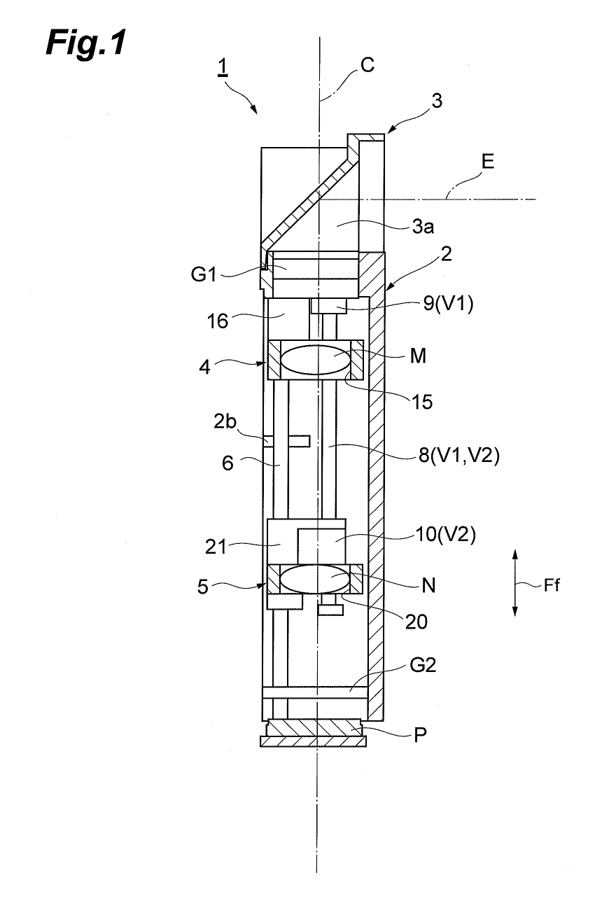

As shown in FIG. 1 to FIG. 4, a lens drive device 1 according to a first embodiment is built in, for example, a slim digital camera or a portable information terminal with an imaging function, for driving a zoom lens M and a focus lens N. The zoom lens M and the focus lens N are formed with a plurality of lenses.

In the lens drive device 1, the zoom lens M and the focus lens N are arranged such that their optical axes C coincide with each other. The lens drive device 1 drives the zoom lens M and the focus lens N in the direction along the optical axis C (hereinafter referred to as “optical axis direction C”). An imaging unit P including a CCD (charge coupled device) image sensor is provided outside the lens drive device 1.

The lens drive device 1 includes a base member 2, a light bending portion 3, a first lens frame 4, a second lens frame 5, guide shafts 6 and 7, a magnet 8, a first coil 9, a second coil 10, an FPC (flexible printed circuits) 11, a first photoreflector 12, and a second photoreflector 13.

The base member 2 is a flat box-shaped member that accommodates the zoom lens M and the focus lens N. The longitudinal direction of the base member 2 coincides with the optical axis direction C. Fixed lenses G1 and G2 are provided to the base member 2 to sandwich the zoom lens M and the focus lens N on the optical axis C.

The light bending portion 3 is a member provided outside the base member 2 for bending an optical axis E of subject light from a subject toward the base member 2. The light bending portion 3 includes an approximately triangular prism-shaped prism 3a. The light bending portion 3 bends the optical axis E of subject light with the prism 3a at the right angle toward the optical axis direction C and emits the light toward the zoom lens M and the focus lens N inside the base member 2. The subject light emitted from the light bending portion 3 passes through the fixed lens G1, the zoom lens M, the focus lens N, and the fixed lens G2 in this order to be emitted outside the base member 2 and detected by the imaging unit P.

The first lens frame 4 and the second lens frame 5 are rectangular plate-shaped members that hold the zoom lens M and the focus lens N, respectively. The first lens frame 4 is described below.

A lens hole 15 in which the zoom lens M is fitted is formed at the center of the first lens frame 4. Shaft sliding portions 16 and 17 are formed on both ends of the first lens frame 4. The shaft sliding portions 16 and 17 have insertion holes through which the guide shafts 6 and 7 extending in the optical axis direction C are inserted, respectively. The guide shafts 6 and 7 are members fixed to the base member 2 for guiding the movement of the first lens frame 4 in the optical axis direction C. One ends of the guide shafts 6 and 7 protrude from the base member 2 to be fixed to the imaging unit P.

The first lens frame 4 is moved by a first drive unit (driving means) V1 in the optical axis direction C along the guide shafts 6 and 7. The first lens frame 4 moves between a side wall 2a at the light bending portion 3 side and a stopper portion 2b of the base member 2. The first drive unit V1 is a linear actuator including a rod-like magnet 8 fixed to the base member 2 and the first coil 9 fixed to the first lens frame 4. The magnet 8 is arranged to extend in the optical axis direction C inside the base member 2 and is alternately magnetized with the North pole and the South pole in the optical axis direction C.

The first coil 9 is integrally fixed with the shaft sliding portion 16 of the first lens frame 4. That is, the shaft sliding portion 16 also functions as a coil holding portion holding the first coil 9. The magnet 8 is inserted through an air core portion of the first coil 9. The first drive unit V1 drives the first lens frame 4 with thrust produced between the first coil 9 and the magnet 8 by energization.

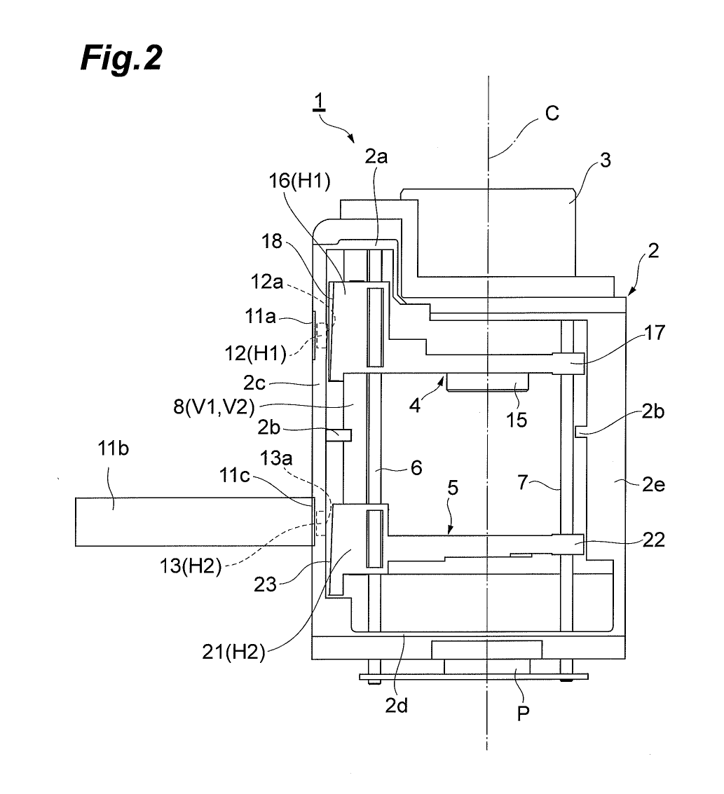

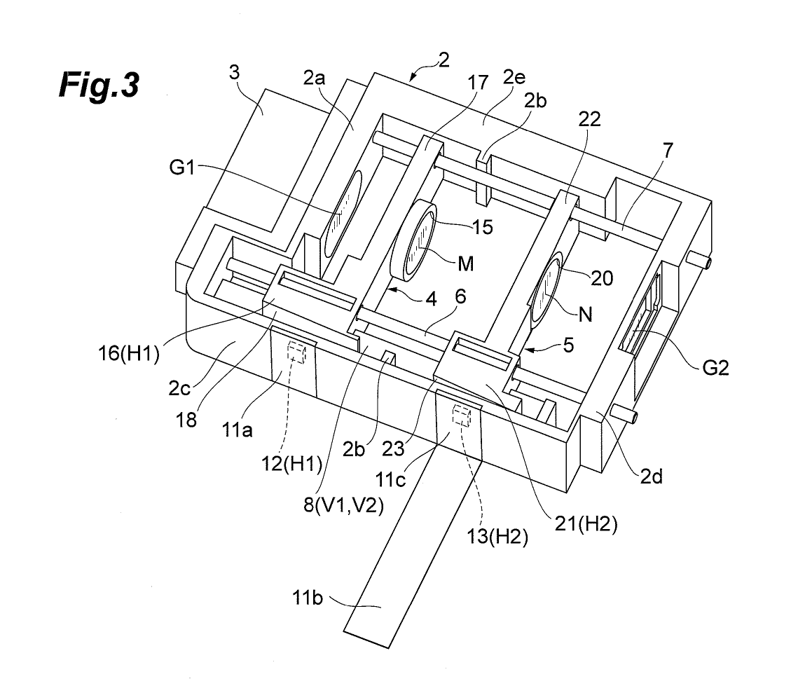

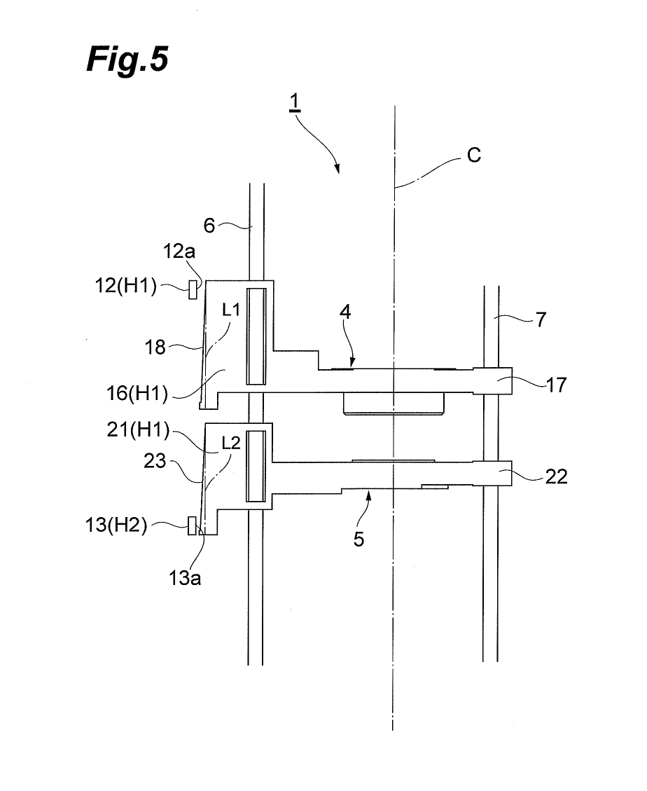

As shown in FIG. 2, FIG. 3, and FIG. 5, the shaft sliding portion 16 of the first lens frame 4 also functions as a reflection portion that reflects light from the first photoreflector 12. A reflection flat surface 18 is formed on a side surface of the shaft sliding portion 16. This reflection flat surface 18 is provided inclined with respect to the optical axis C. L1 shown in FIG. 5 is an imaginary line parallel to the optical axis C. The reflection flat surface 18 is inclined in a direction further away from the optical axis C as it approaches the exit side, that is, the fixed lens G2 side of the base member 2 in the optical axis direction C.

The first photoreflector 12 is buried in the side wall 2c of the base member 2 and has a light projecting/receiving surface 12a exposed on the inside of the base member 2. A first connection end portion 11a of the FPC 11 is connected to the back surface of the first photoreflector 12. The first connection end portion 11a is joined with a terminal 11b of the FPC 11 at the front side of the base member 2.

The first photoreflector 12 has a light projecting portion applying light to the reflection flat surface 18 and a light receiving portion receiving light reflected on the reflection flat surface 18 (neither shown in the drawings). The first photoreflector 12 is arranged such that the light projecting/receiving surface 12a faces the reflection flat surface 18. That is, the first photoreflector 12 is arranged such that the light projecting/receiving surface 12a is parallel to the reflection flat surface 18.

The first photoreflector 12 and the shaft sliding portion 16 having the reflection flat surface 18 function as a first position detection unit (position detection means) H1 for detecting the position of the first lens frame 4. In the first position detection unit H1, the distance between the light projecting/receiving surface 12a of the first photoreflector 12 and the reflection flat surface 18 changes in accordance with the position of the first lens frame 4. The first photoreflector 12 thus detects the distance between the light projecting/receiving surface 12a and the reflection flat surface 18 thereby detecting the position of the first lens frame 4.

The second lens frame 5 is now described. As shown in FIG. 1 to FIG. 4, a lens hole 20 in which the focus lens N is fitted is formed at the center of the second lens frame 5. The second lens frame 5 and the first lens frame 4 have almost the same configuration.

Shaft sliding portions 21 and 22 are provided on both ends of the second lens frame 5. The shaft sliding portions 21 and 22 have insertion holes through which the guide shafts 6 and 7 extending in the optical axis direction C are inserted, respectively. The second lens frame 5 moves between the stopper portion 2b and a side wall 2d at the imaging unit P side of the base member 2 along the guide shafts 6 and 7. The second lens frame 5 is moved by a second drive unit (driving means) V2 in the optical axis direction C.

The second drive unit V2 is a linear actuator including the rod-like magnet 8 fixed to the base member 2 and the second coil 10 fixed to the second lens frame 5. The second drive unit V2 drives the second lens frame 5 with thrust produced between the second coil 10 and the magnet 8 by energization. The second coil 10 is integrally fixed with the shaft sliding portion 21 of the second lens frame 5. That is, the shaft sliding portion 21 also functions as a coil holding portion holding the second coil 10.

As shown in FIG. 2, FIG. 3, and FIG. 5, the shaft sliding portion 21 of the second lens frame 5 also functions as a reflection portion that reflects light from the second photoreflector 13. A reflection flat surface 23 is formed on a side surface of the shaft sliding portion 21. This reflection flat surface 23 is provided inclined with respect to the optical axis C. L2 shown in FIG. 5 is an imaginary line parallel to the optical axis C. The reflection flat surface 23 is inclined in a direction further away from the optical axis C as it approaches the exit side, that is, the fixed lens G2 side of the base member 2 in the optical axis direction C.

The second photoreflector 13 is buried in the side wall 2c of the base member 2 such that a light projecting/receiving surface 13a is exposed on the inside. A second connection end portion 11c of the FPC 11 is connected to the back surface of the second photoreflector 13.

The second photoreflector 13 has a light projecting portion applying light to the reflection flat surface 23 and a light receiving portion receiving light reflected on the reflection flat surface 23 (neither shown in the drawings). The second photoreflector 13 is arranged such that the light projecting/receiving surface 13a faces the reflection flat surface 23. That is, the second photoreflector 13 is arranged such that the light projecting/receiving surface 13a is parallel to the reflection flat surface 23. The second photoreflector 13 and the shaft sliding portion 21 having the reflection flat surface 23 function as a second position detection unit (position detection means) H2 for detecting the position of the second lens frame 5.

In the lens drive device 1 having such a configuration, the reflection flat surface 18 of the first lens frame 4 is inclined with respect to the optical axis C, so that the distance between the light projecting/receiving surface 12a of the first photoreflector 12 and the reflection flat surface 18 continuously changes in accordance with the position of the first lens frame 4. Since the reflection flat surface 18 is a flat surface having constant inclination, the position of the first lens frame 4 can be specified based on the distance between the reflection flat surface 18 and the light projecting/receiving surface 12a. The lens drive device 1 therefore can detect the distance from the reflection flat surface 18 using the first photoreflector 12 thereby precisely specifying the position of the first lens frame 4 corresponding to the detected distance. Accordingly, lens position detection can be performed with high accuracy and high resolution.

In this lens drive device 1 compared with a case where the first photoreflector 12 directly detects the moving distance of the first lens frame 4, the device can be reduced in size in the optical axis direction C because the first photoreflector 12 and the reflection flat surface 18 do not have to be opposed to each other in the optical axis direction C. Furthermore, in this lens drive device 1 compared with the case where the first photoreflector 12 directly detects the moving distance of the first lens frame 4, the distance detection range required of the first photoreflector 12 can be reduced. This is advantageous in terms of size reduction and cost reduction of the first photoreflector 12.

This lens drive device 1 employs a configuration in which the light projecting/receiving surface 12a and the reflection flat surface 18 face each other, so that light can be reliably projected/received by the photoreflector compared with a case where the light projecting/receiving surface 12a and the reflection flat surface 18 do not face each other. The detection accuracy of the photoreflector is thus improved.

In this lens drive device 1, the coil holding portion holding the first coil 9, the reflection portion having the reflection flat surface 18, and the shaft sliding portion 16 sliding along the guide shaft 6 are integrally formed in the first lens frame. Accordingly, compared with a case where the coil holding portion, the reflection portion, and the shaft sliding portion are separately provided, the structure is significantly simplified thereby achieving size reduction of the device. This lens drive device 1 can also achieve the various effects as described above for the second lens frame 5.

Control of lens position detection in the lens drive device 1 will now be described by taking the focus lens N as an example.

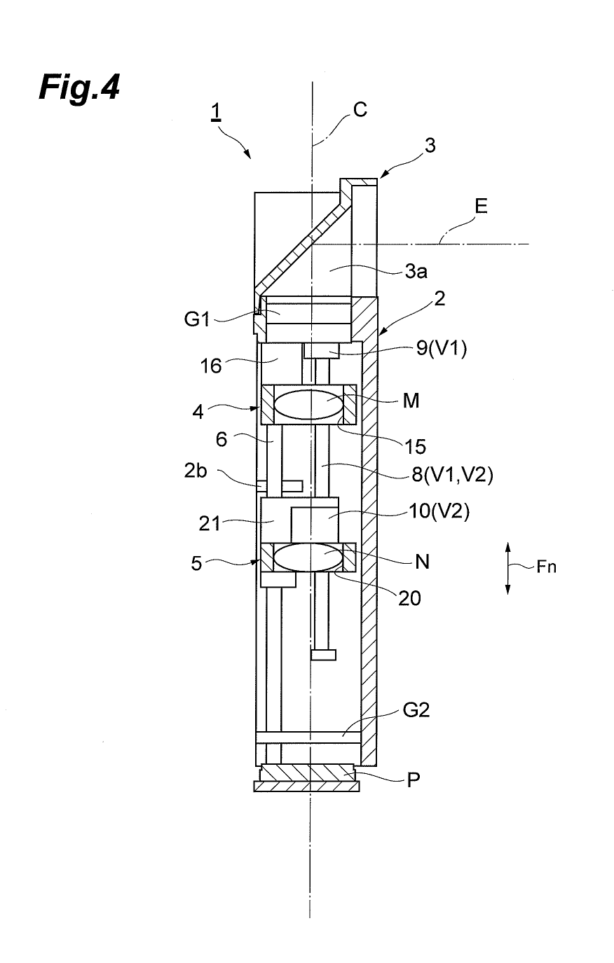

FIG. 4 shows a state in which the focus lens N is located in a fine movement area Fn. FIG. 1 shows a state in which the focus lens N is located in a coarse movement area Ff. The fine movement area Fn refers to the position range of the focus lens N to be used to focus on a subject at a short distance, in which minute lens position detection is required. The coarse movement area Ff refers to the position range of the focus lens N to be used to focus on a subject at a long distance, in which adjustment can be made with lens position detection coarser than the fine movement area Fn. The fine movement area Fn corresponds to a lens position detection area for short distance, and the coarse movement area Ff corresponds to a lens position detection area for long distance.

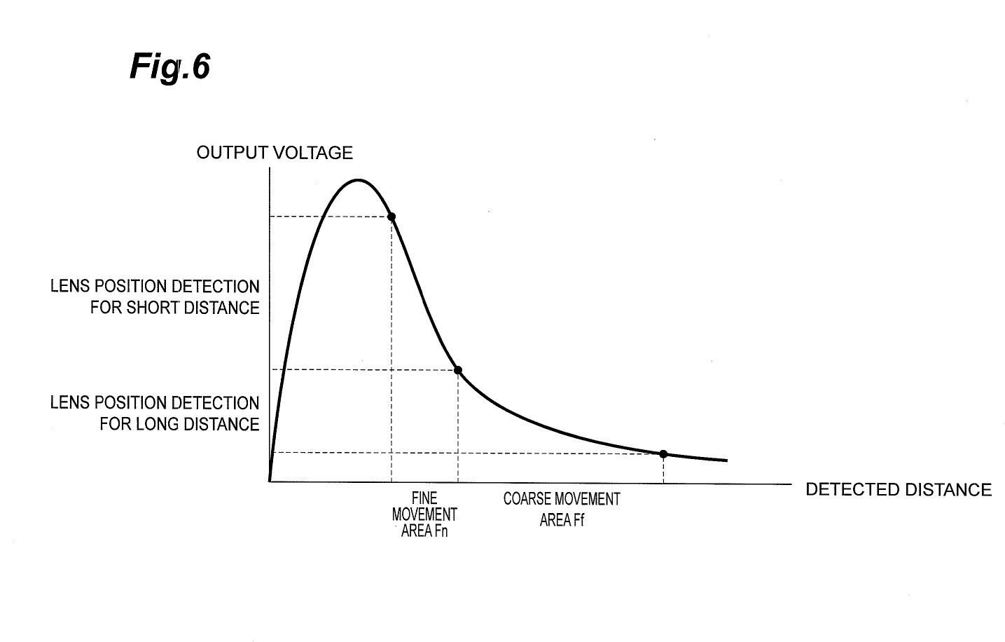

Here, FIG. 6 is a graph for explaining the fine movement area Fn and the coarse movement area Ff in an output voltage characteristic of the second photoreflector 13. The output voltage characteristic of the second photoreflector 13 means the relationship between the detected distance and the output voltage of the second photoreflector 13. The detected distance refers to the distance, which is detected by the second photoreflector 13, between the light projecting/receiving surface 13a and the reflection flat surface 23. In FIG. 6, the ordinate indicates the output voltage, and the abscissa indicates the detected distance.

As shown in FIG. 6, the output voltage characteristic of the second photoreflector 13 is represented as a curve that rises from the zero distance up to a predetermined peak as the detected distance increases and that gradually drops in accordance with the length of the detected distance after reaching the maximum at the peak distance. In such an output voltage characteristic, the greater is the rate of change of the output voltage with respect to the detected distance, the finer position detection is achieved by measuring the output voltage. Based on this, a range in which the rate of change is high is set as the fine movement area Fn. In addition, a range in which linearity is high, that is, there are small variations in the rate of change is selected as the fine movement area Fn to ensure accuracy. In the coarse movement area Ff, in which case fine position detection is not required, a range in which the rate of change is low is set. In FIG. 6, a range in which the output voltage characteristic of the second photoreflector 13 after the output voltage exceeds the peak is set as the fine movement area Fn and the coarse movement area Ff.

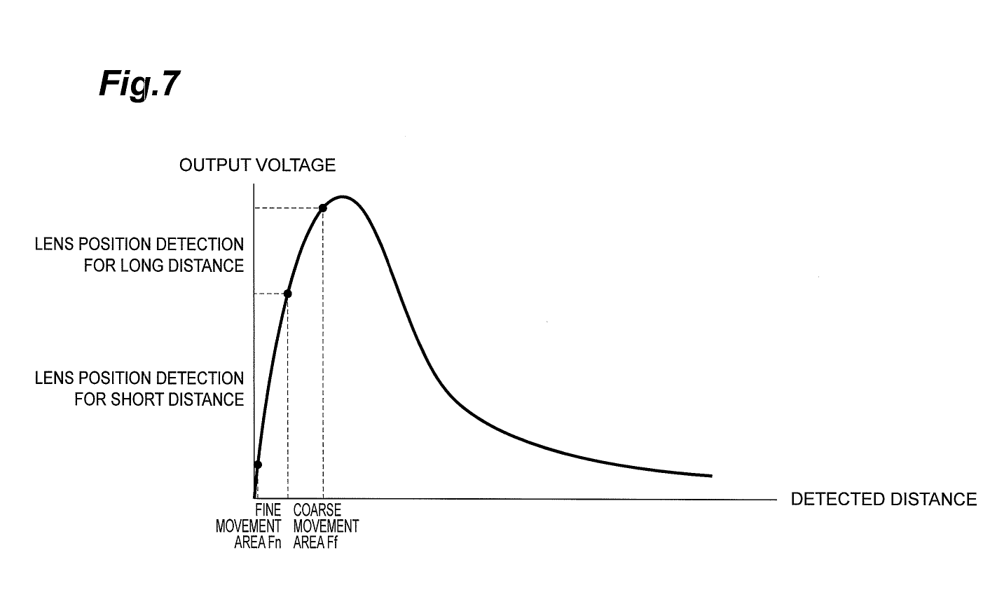

FIG. 7 is a graph showing an example in which a range of the output voltage characteristic of the second photoreflector 13 before the output voltage exceeds the peak is set as the fine movement area Fn and the coarse movement area Ff. In FIG. 7, in the range before the output voltage exceeds the peak, a range in which the rate of change of the output voltage with respect to the detected distance is high and linearity is high is set as the fine movement area Fn, and a range in which the rate of change is smaller than in the fine movement area Fn is set as the coarse movement area Ff. It is preferable that a range in which linearity is high be set as the coarse movement area Ff.

In this lens drive device 1, the fine movement area Fn for short distance and the coarse movement area Ff for long distance are set in accordance with the magnitude of the rate of change of the output voltage with respect to the detected distance in the output voltage characteristics of the photoreflectors 12 and 13, thereby implementing lens position detection suited for respective imaging conditions for short distance and for long distance.

Moreover, this lens drive device 1 uses the coarse movement area Ff for the lens position detection for long range and uses the fine movement area Fn for the lens position detection for short distance, thereby implementing accurate and fine position detection of the lens N during imaging at a short distance while ensuring the position detection accuracy of lens N that is necessary and sufficient for imaging at a long distance. Accordingly, in this lens drive device 1 compared with a case where a range in which the rate of change of the output voltage with respect to the detected distance is high and linearity is high is used both for the fine movement area Fn and for the coarse movement area Ff, the available range of the output voltage characteristic for the fine movement area Fn can be enlarged, thereby enabling accurate lens position detection during imaging at a short distance. This contributes to improvement of imaging performance of the camera for imaging at a short distance.

### Second Embodiment

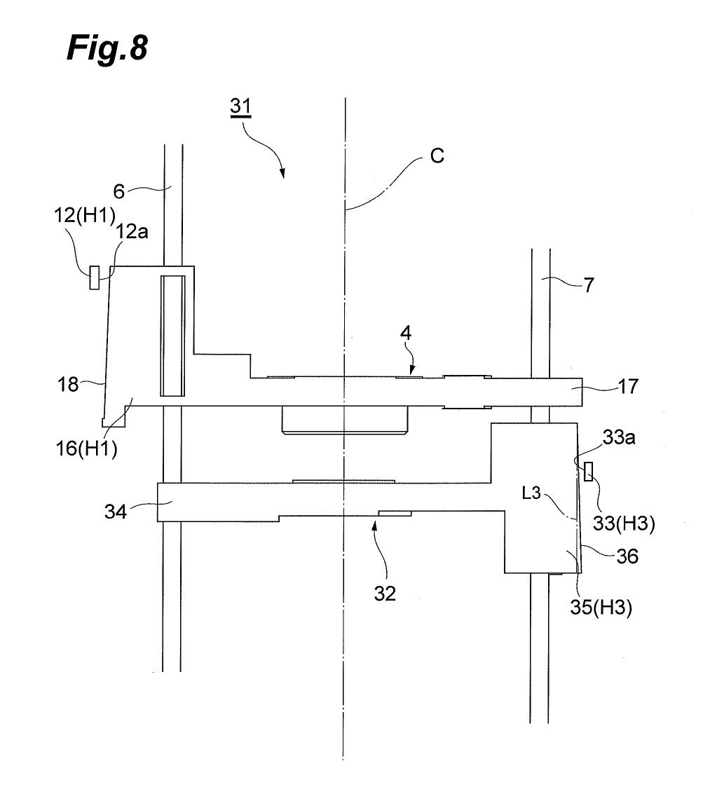

As shown in FIG. 8, a lens drive device 31 according to a second embodiment differs from the lens drive device 1 according to the first embodiment mainly in the shape of a second lens frame 32 and the position of a second photoreflector 33.

Specifically, in the second lens frame 32 according to the second embodiment, of shaft sliding portions 34 and 35, the shaft sliding portion 35 located opposite to the shaft sliding portion 16 of the first lens frame 4 has a reflection flat surface 36. The reflection flat surface 36 is a flat surface inclined with respect to the optical axis C. FIG. 8 shows an imaginary line L3 parallel to the optical axis C. The second photoreflector 33 is arranged opposite to the first photoreflector 13 so as to face the reflection flat surface 36.

The lens drive device 31 having such a configuration also achieves the similar effects as in the lens drive device 1 according to the first embodiment. It is advantageous in size reduction of the device in the optical axis direction C because the shaft sliding portion 16 of the first lens frame 4 and the shaft sliding portion 35 of the second lens frame 5, which have their lengths in the optical axis direction C, are arranged on different guide shafts.

### Third Embodiment

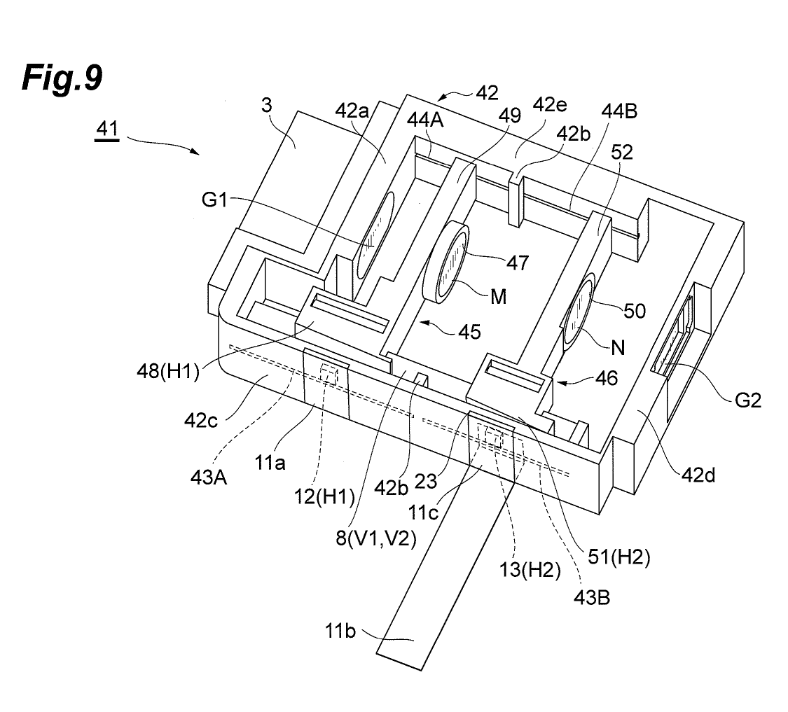

As shown in FIG. 9, a lens drive device 41 according to a third embodiment differs from the lens drive device 1 according to the first embodiment mainly in that the guide shafts 6 and 7 are replaced with guide grooves 43 and 44 which guide a first lens frame 45 and a second lens frame 46.

The guide groove 43 extending in the optical axis direction C is formed on the inner surface of a side wall 42c in a base member 42 of the lens drive device 41 according to the third embodiment. The guide groove 43 is divided by a stopper portion 42b formed on the inside of the side wall 42c into a groove 43A for the first lens frame 45 and a groove 43B for the second lens frame 46. Similarly, the guide groove 44 extending in the optical axis direction C is formed on the inner surface of a side wall 42e of the base member 42. This guide groove 44 is also divided into a groove 44A for the first lens frame 45 and a groove 44B for the second lens frame 46.

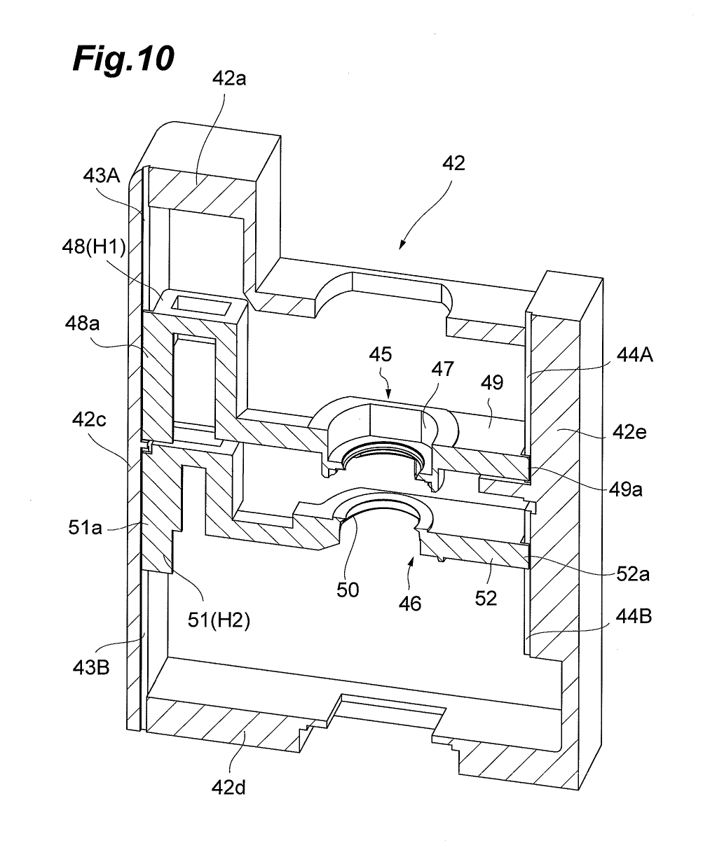

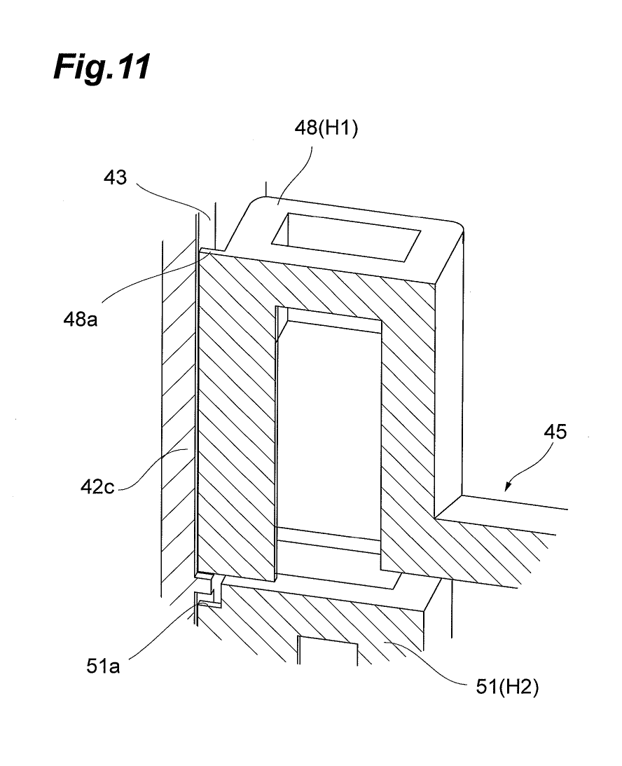

FIG. 10 and FIG. 11 are sectional views cut along the guide grooves 43 and 44. In FIG. 10 and FIG. 11, only the base member 42, the first lens frame 45, and the second lens frame 46 are shown for the sake of easy understanding.

As shown in FIG. 10 and FIG. 11, guide sliding portions 48 and 49 opposed to the guide grooves 43A and 44A, respectively, are formed on both ends of the first lens frame 45. A guide projection portion 48a engaged with the guide groove 43A is formed in the guide sliding portion 48. A guide projection portion 49a engaged with the guide groove 44A is formed in the guide sliding portion 49. These guide projection portions 48a and 49a extend in the optical axis direction C.

Similarly, guide sliding portions 51 and 52 opposed to the guide grooves 43A and 44A, respectively, are formed on both ends of the second lens frame 46. A guide projection portion 51a engaged with the guide groove 43B is formed in the guide sliding portion 51. A guide projection portion 52a engaged with the guide groove 44B is formed in the guide sliding portion 52. These guide projection portions 51a and 52a extend in the optical axis direction C.

In this lens drive device 41, the guide projection portions 48a and 49a engaged with the guide grooves 43A and 44A of the base member 42 slide in the guide grooves 43A and 44A, respectively, in accordance with the movement of the first lens frame 45, so that the first lens frame 45 can be moved accurately in the optical axis direction C. The lens drive device 41 can achieve the similar effects for the movement of the second lens frame 46.

The lens drive device 41 eliminates the need for the guide shafts, thereby reducing the number of components and reducing the cost of the device. This configuration is also advantageous in size reduction of the device.

The present invention is not limited to the foregoing embodiments.

For example, the imaging device according to the present invention includes, in addition to a digital camera, a portable information terminal such as a mobile phone with an imaging function, a portable personal computer, and a PDA.

The photoreflectors 12 and 13 and the reflection flat surfaces 18 and 23 may be in an inversed positional relationship. Specifically, the photoreflectors 12 and 13 may be provided to the lens frames, and the reflection flat surfaces 18 and 23 may be provided on the base member 2. The respective light projecting/receiving surfaces 12a and 13a of the photoreflectors 12 and 13 are not necessarily arranged parallel to the reflection flat surfaces 18 and 23.

In the output voltage characteristic of the photoreflector 11, the functions of the fine movement area Fn and the coarse movement area Ff may be switched. Specifically, the fine movement area Fn in which the rate of change of the output voltage with respect to the detected distance is high may be set as a lens detection area for long distance while the coarse movement area Ff in which the rate of change is low may be set as a lens detection area for short distance.

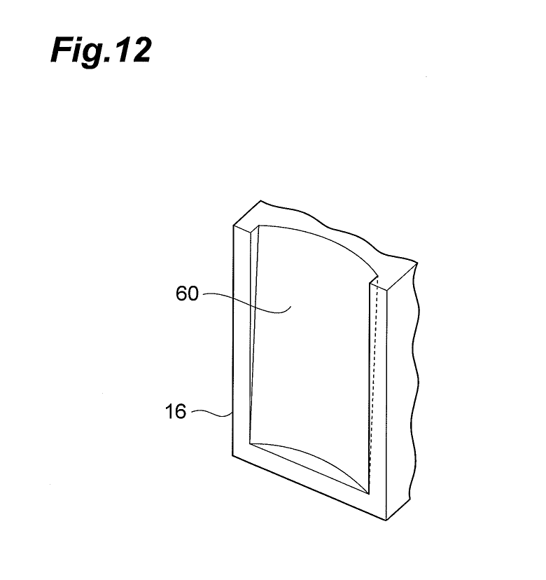

As shown in FIG. 12, the reflection surface is formed as a reflection curved surface 60 inclined with respect to the optical axis C of the lens N. This reflection curved surface 60 is a concave mirror capable of collecting light. The reflection surface formed with the curved surface 60 capable of collecting light enables sensing light efficiently with a small quantity of light and improving the accuracy of position detection even if the shaft sliding portion (reflection portion) 16 is small.

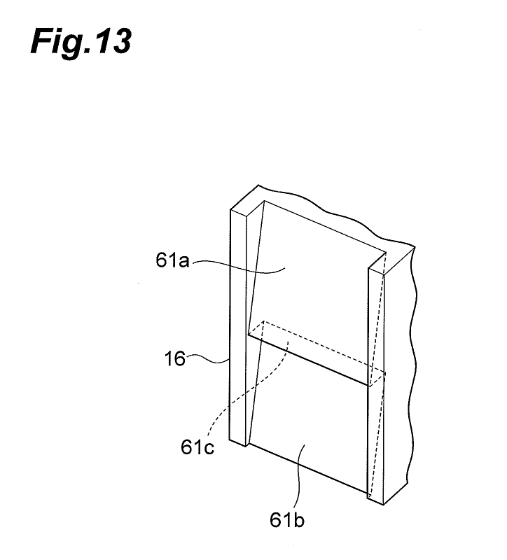

As shown in FIG. 13, the reflection surface is formed in a sawtooth shape in a cross section. The reflection surface has two reflection surfaces 61a and 61b having the same inclination angle. The inclination angle of each of the reflection surfaces 61a and 61b having a planar shape is greater than that of the reflection flat surface 18 described above, and a step portion 61c that is not inclined is arranged between the reflection surface 61a and the reflection surface 61b. By employing such a configuration, the inclination angle of the reflection surfaces 61a and 61b can be increased. This can increase a change in the amount of receiving light and can improve the accuracy of position detection even if the shaft sliding portion (reflection portion) 16 is small. The reflection surfaces 61a and 61b may be formed as curved surfaces, and a plurality of step portions 61c may be arranged in parallel in the optical axis C direction.

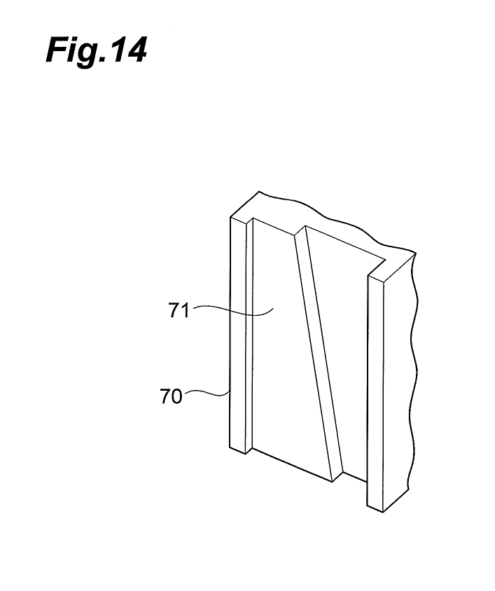

As shown in FIG. 14, the area of a reflection surface 71 of a reflection portion 70, which functions as a shaft sliding portion, as a related technique may be varied so as to continuously increase or decrease in the optical axis direction. In this manner, the reflection area of the reflection surface 71 is varied to change the amount of receiving light, thereby enabling position detection.

The reflection portions shown in FIG. 12 to FIG. 14 may be applied to the shaft sliding portions 21, 35, 48, and 51.

The reflection surfaces 18, 23, 34, 60, 61a, 61b, and 71 as described above can be applied to either of folded optics with an optical path bent by a prism and retractable optics with a barrel shrunken and stored in the main body. The lens drive devices 1, 31, and 41 have the folded optics.

An IR cut filter (not shown) may be arranged in front of an imaging unit P on the optical axis C. By employing the IR cut filter, imaging unit P does not receive infrared rays emitted from the light projecting portions of the photoreflectors 12 and 13. Thus, it is possible to prevent influence of the infrared rays on imaging. Accordingly, the photoreflectors 12 and 13 are easily arranged in the vicinity of an imaging element, which contributes to size reduction of the lens drive devices 1, 31, and 41.

### REFERENCE SIGNS LIST

1, 31, 41 lens drive device
2, 42 base member
2a, 2c, 2d, 2e side wall
2b stopper portion
3 light bending portion
3a prism
4, 45 first lens frame
5, 46 second lens frame
6, 7 guide shaft
8 magnet
9 first coil
10 second coil
12 first photoreflector
12a, 13a light projecting/receiving surface
13, 33 second photoreflector
13a light projecting/receiving surface
16, 21, 35, 48, 51, 70 shaft sliding portion (reflection portion, coil holding portion)
17, 22, 34, 49, 52 shaft sliding portion
18, 23, 36, 61a, 61b, 71 reflection flat surface (reflection surface)
42b stopper portion
48a, 49a, 51a, 52a guide projection portion
60 reflection curved surface (reflection surface)
C optical axis
E optical axis of subject light
Ff coarse movement area
Fn fine movement area
G1 fixed lens
G2 fixed lens
H1 first position detection unit (position detection means)
H2 second position detection unit (position detection means)
M zoom lens
N focus lens
P imaging unit
V1 first drive unit (driving means)
V2 second drive unit (driving means)

1-9. (canceled)

10. A lens drive device comprising:
a base;
a lens frame holding a lens and provided to be movable with respect to the base in an optical axis direction of the lens;
a light bending portion provided outside the base for bending incident light on the lens;
driving unit configured to move the lens frame, and
position detection unit configured to detect a position of the lens frame, wherein
the position detection unit includes
a reflection portion provided to one of the base and the lens frame and including a reflection surface inclined with respect to the optical axis of the lens, and
a photoreflector provided to the other of the base and the lens frame and including a light projecting portion applying light to the reflection surface and a light receiving portion receiving light reflected on the reflection surface.

11. The lens drive device according to claim 10, wherein
the reflection surface of the reflection portion and a light projecting/receiving surface of the photoreflector face each other.

12. The lens drive device according to claim 10, wherein
the reflection portion is provided to the lens frame,
the driving unit includes a magnet provided to the base and a coil provided to the lens frame, and
the lens frame includes a coil holding portion integrally formed with the reflection portion for holding the coil.

13. The lens drive device according to claim 10, wherein in an output voltage characteristic of the photoreflector with respect to a distance between the photoreflector and the reflection surface, a range in which a rate of change of the output voltage with respect to the distance is high is set as a lens position detection area for either a lens position detection area for short distance or a lens position detection area for long distance, and another range in which the rate of change is smaller than in the range is set as the other lens position detection area.

14. The lens drive device according to claim 10, wherein
the base has a guide groove extending in the optical axis direction, and
the lens frame includes a projection portion that is engaged with the guide groove and is slidable along the guide groove.

15. The lens drive device according to claim 10, wherein the reflection surface is a flat surface or a curved surface capable of collecting light.

16. The lens drive device according to claim 15, wherein the reflection surface is formed in a sawtooth shape in a cross section.

17. An imaging device comprising the lens drive device according to claim 10.

18. A lens drive device comprising:
a base;
a lens frame holding a lens and provided to be movable with respect to the base in an optical axis direction of the lens;
a light bending portion provided outside the base for bending incident light on the lens;
driving means for moving the lens frame, and
position detection means for detecting a position of the lens frame, wherein
the position detection means includes
a reflection portion provided to one of the base and the lens frame and including a reflection surface inclined with respect to the optical axis of the lens, and
a photoreflector provided to the other of the base and the lens frame and including a light projecting portion applying light to the reflection surface and a light receiving portion receiving light reflected on the reflection surface.
